(19) United States
(12) Patent Application Publication
(10) Pub. No.: US 2001/0011431 A1
(43) Pub. Date: Aug. 9, 2001

(54) Method and apparatus for conveying unique visual communication

(76) Inventor: Brian K. Elias, Springboro, OH (US)

Correspondence Address: BIEBEL & FRENCH LPA, 35 East First Street, Dayton, OH, 45402, US

(21) Appl. No.: 09/814,191

(22) Filed: Mar. 21, 2001

Related U.S. Application Data
(63) Continuation-in-part of application No. 09/448,228, filed on Nov. 24, 1999.
(60) Provisional application No. 60/109,948, filed on Nov. 25, 1998.

(51) Int. Cl. G09F 3/00

(52) U.S. Cl. 40/306

(57) ABSTRACT

An apparatus and related method for identifying containers. The apparatus comprises a container supporting convenient modification means which when selectively altered effectively changes the appearance of the container such that a unique visual communication is produced. The related method comprises selectively altering the modification means supported by the container thereby providing a unique visual communication.

### CROSS REFERENCE TO RELATED APPLICATIONS

This application is a continuation-in-part of U.S. patent application Ser. No. 09/448,228, filed Nov. 24, 1999, which claims priority to U.S. Provisional Application Ser. No. 60/109,948, filed Nov. 25, 1998, both applications incorporated herein by reference.

### BACKGROUND OF THE INVENTION

1. Field of the Invention

The present invention relates to containers and container labels, and more particularly, to containers and container labels which can be conveniently modified to provide simple and effective ways for users to visually personalize, distinguish, mark or communicate information via the containers themselves, or their associated labels.

2. Description of the Prior Art

Typical construction and labeling of containers does not commonly provide means for visually communicating unique or identifying information. Users of a container often have the need to visually distinguish their container from another of the same brand and name, for example, to prevent accidental consumption of a beverage by someone other than the user of a container, or to obviate the owner of a container to avoid misidentification; to record information regarding the contents of the container, for example date of purchase, date container was first opened, volume of the container's contents consumed or remaining, amount of solute or solvent in the container; and to effect other visual signals, for example to indicate to a bar tender or server that the container is empty or near empty and another full container having the same contents is desired.

Traditional means used to visually personalize, distinguish, mark or communicate information via a container or its associated label involve the permanent physical marking or destruction of the container label. This way of communicating is both inconvenient and inconsistent, as a device for marking the container is required and uniformity of marking location is non-existent. Alternate means, as disclosed in U.S. Pat. No. 5,704,144 to Groth and U.S. Design patent No. to Kesselring et al., require the affixation of an identification tag to the container. Such traditional marking means are typically expensive and do not permit convenient customization by the end user.

Accordingly, there remains a need for a method and apparatus for effecting easy visual communication by modifying the appearance of a container or container label.

### SUMMARY OF INVENTION

An easy opening can container in accordance with this invention includes a cylindrical wall of sheet material. Opposing upper end and lower end walls are connected to opposite ends of the cylindrical wall. A tab is rotatably and pivotally attached at a connection point proximate to the center of the upper end wall. A plurality of visual indicia comprised of letters, numbers, words, names, symbols or other graphic representations are disposed in a series on the upper end wall radially outwardly from the connection point of the tab. The visual indicia are circumferentially aligned along a path of rotation of the tab.

The visual indicia may be imprinted on the upper end wall with ink or other marking means, or alternatively, die cut or embossed into the sheet material during manufacture. The tab supports an indicator selectively moveable into alignment with the series of visual indicia. More particularly, when the tab is rotated, the tab glides circumferentially across the upper end wall of the container. As the tab is rotated, the indicator may be selectively positioned in alignment with one of the visual indicia located on the upper end wall of the can. The positioning of the indicator in alignment with one of the visual indicia provides a unique visual communication.

A further embodiment of the present invention comprises an easy opening can container as described above, wherein the tab is moved into substantial perpendicular disposition with the upper end wall of the can container. This movement is effected by manually pulling the outer edge of the tab upwardly away from the upper end wall of the can into the aforementioned substantial perpendicular disposition. The resultant positioning of the tab effects a unique visual communication. This communication may effect a signal to a bar tender or server that the container is empty or near empty and that another full container having the same or similar contents is desired.

In a related embodiment, the tab is further modified or shaped to include visual indicia which further emphasizes the signal to a bar tender or server that the container is empty or near empty and that another full container having the same contents is desired. The visual indicia on the tab may consist of a mark, shape, incising, imprint, color, depression, cut, mold, impression, etc. visually forming a symbol, number, letter, word, name, graphic, or other visual cue. In a further related embodiment, the modification or shaping of the tab is accomplished by modifying or shaping the underside of the tab only, such that the signal effected by the tab is only visible when the tab is upwardly extended away from the upper end wall of the can container.

Therefore, it is an object of the invention to provide a container for providing a unique visual communication.

It is an additional object of the invention to provide such a container which may be readily modified by the end user to effectively change the appearance thereof.

It is a further object of the invention to provide such a container which may be readily modified by the end user to visually distinguish the container from other like containers.

It is an additional object of the invention to provide such a container which may be readily modified by the end user to record information regarding the contents of the container, including date of purchase, date the container was first opened, volume of the containers contents either consumed or remaining, or concentration of a solute or solvent contained within the container.

It is a further object of the invention to provide such a container which may be readily modified by the end user to signal a bar tender or server that the container is empty or near empty and another full container having the same contents is desired.

Other objects and advantages of the invention will be apparent from the following description, accompanying drawings and appended claims.

### BRIEF DESCRIPTION OF THE DRAWINGS

FIG. 1 is a perspective view of a conventional easy opening can container;

FIG. 2 is a top plan view of an easy opening can container in accordance with the invention;

FIG. 3 is a top plan view of an easy opening can container demonstrating an alternative embodiment of the invention;

FIG. 4 is a perspective view of a further embodiment of an easy opening can container in accordance with the invention, illustrating the upper surface of the tab moved into substantially perpendicular disposition with the upper end wall;

FIG. 5 is a perspective view of another embodiment of an easy opening can container in accordance with the invention, illustrating the lower surface of the tab moved into substantially perpendicular disposition with the upper end wall; and

FIG. 6 is a perspective view of another embodiment of an easy opening can container in accordance with the invention, illustrating visual indicia supported by the tab and comprising the shape of a hand.

### DESCRIPTION OF THE PREFERRED EMBODIMENTS

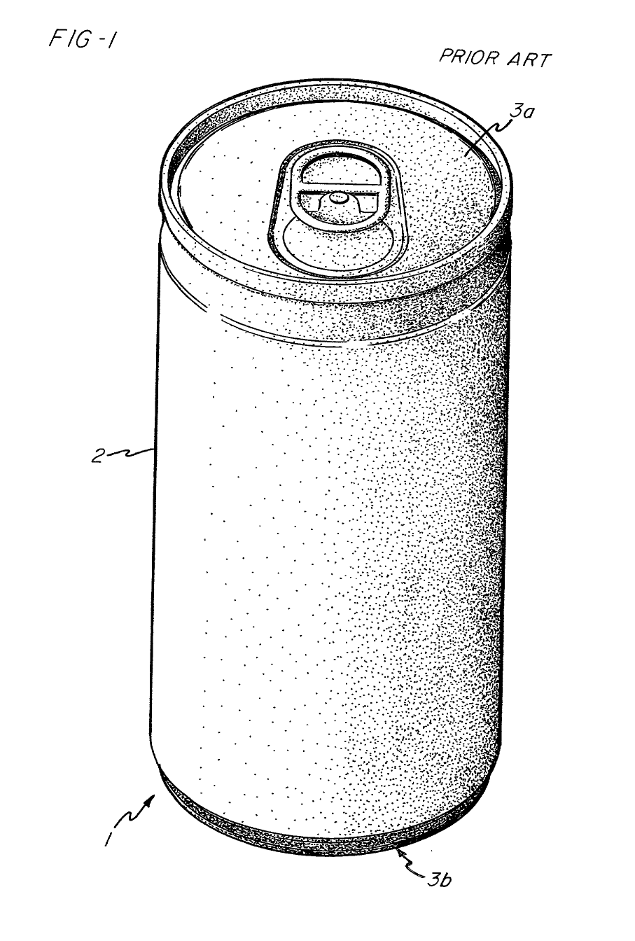

FIG. 1 illustrates an easy opening container 1 similar in type to that disclosed in U.S. Pat. No. 3,730,379 to Brown which is incorporated herein by reference. While an easy opening container 1 is used in the following description, it is to be understood that this for illustrative purposes only and in no way limits the scope of the invention. The container 1 includes a cylindrical wall 2 preferably formed of sheet material. Upper and lower end walls 3a and 3b are preferably formed from sheet material and connected to opposing ends of the cylindrical wall 2.

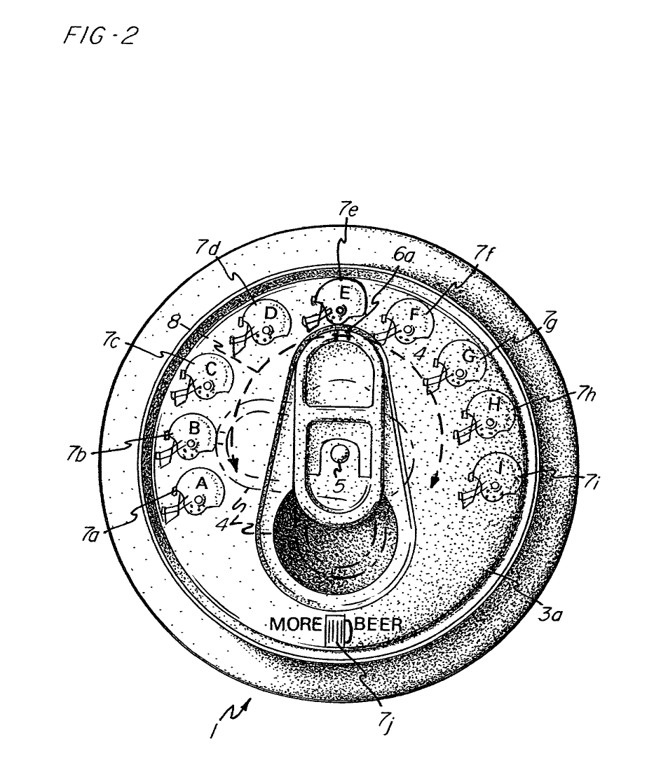

Turning now to FIG. 2, a tab 4 is rotatably and pivotally attached at a connection point 5 proximate to the center of the upper end wall 3 a. The rotatable tab 4 has an indicator 6a preferably comprised of a narrow linear depression formed in the rotatable tab 4 proximate to the end thereof. The indicator 6a may comprise a mark, shape, depression, cut, notch, mold, bend, aperture or other formable indicator, but is not limited thereto.

A plurality of visual indicia 7a, 7b, 7c etc. are preferably die cut or embossed into the upper end wall 3a. Alternatively, the plurality of visual indicia 7a, 7b, 7c etc may be imprinted on the upper end wall 3a with ink or other marking means. Each of the plurality of visual indicia 7a, 7b, 7c etc. is preferably comprised of a unique graphical image. Most preferably the visual indicia comprise a plurality of visually appealing symbols, including a request symbol 7j signaling the desire for more beverage. However, any unique visual indicia, such as letters, numbers, words, names, symbols or other graphic representation may be readily substituted therefor. The plurality of visual indicia 7a, 7b, 7c etc. are disposed in a series on the upper end wall 3a radially outwardly from the connection point 5 of the rotatable tab 4. The plurality of visual indicia 7a, 7b, 7c etc are circumferentially spaced and substantially radially aligned with a path of rotation 8 of the indicator 6a. Each of the visual indicia 7a, 7b, 7c etc., excepting the request symbol 7j, are preferably equally radially spaced along the arc. The request symbol 7j is preferably positioned in spaced relation to the remaining visual indicia to be readily identifiable.

Referring to FIGS. 1 and 2, when the rotatable tab 4 is rotated by a user of the container 1, the rotatable tab 4 moves the indicator 6a circumferentially along the path of rotation 8 above the upper end wall 3a of the container 1. As the rotatable tab 4 is rotated, the indicator 6a of the rotatable tab 4 may be selectively positioned in alignment with any one of the plurality of visual indicia 7a, 7b, 7c etc., located on the upper end wall 3a of the container. The positioning of the indicator 6a in alignment with any one of the plurality of visual indicia 7a, 7b, 7c etc. provides a unique visual communication.

In operation, the preferred embodiment of the present invention may operate to distinguish the appearance of the container 1 from other like containers, so as to indicate ownership. It may also signal the user's desire for another container 1 having the same contents to an attending bar tender or server.

Alternatively, the visual indicia 7a, 7b, 7c as aligned with the indicator 6a may operate to convey information pertaining to the contents of the container, for example, the date of purchase, the date the container was first opened, the volume of the contents of the container either consumed or remaining, or the concentration of a solute or solvent contained within the container. However, it should be appreciated that the selected visual indicia may be used to convey any other communication, for example, “I Love You”, “Interested”, “Not Interested”, “Finished”, etc.

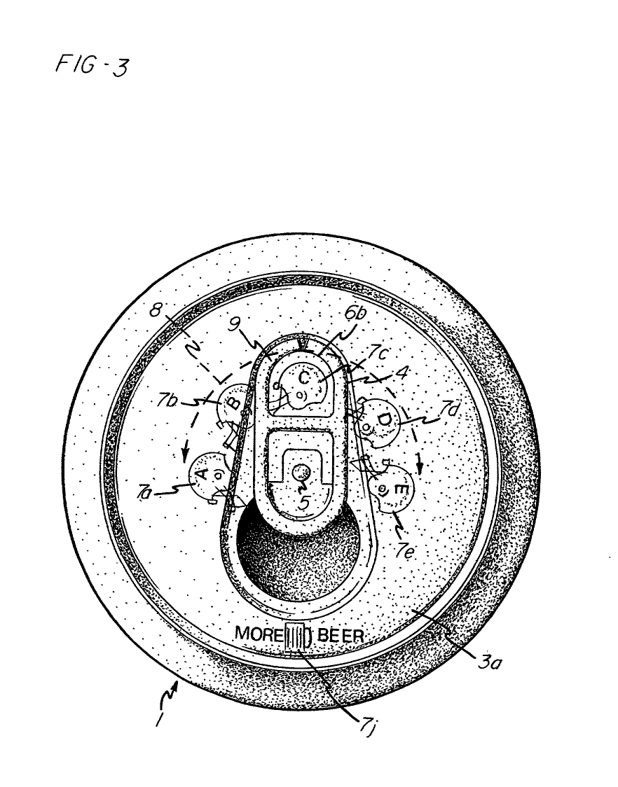

Referring now to FIG. 3, a second embodiment of the invention with an alternate indicator 6b is displayed. The alternate indicator 6b comprises an aperture 9 formed within the tab 4. The aperture 9 is selectively movable into alignment with one of the plurality of visual indicia 7a, 7b, 7cetc. for providing a unique visual communication. More particularly, the selected visual indicia (7c as shown in FIG. 3) is visible through the aperture and formed within the tab 4. In this second embodiment, the unique visual communication may operate to convey any of the aforementioned communications of the preferred embodiment.

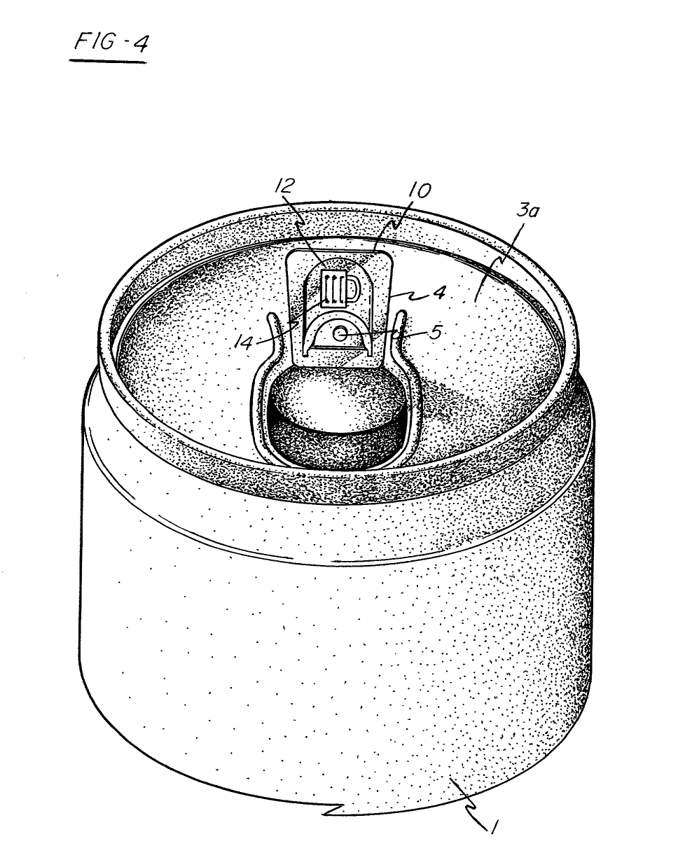

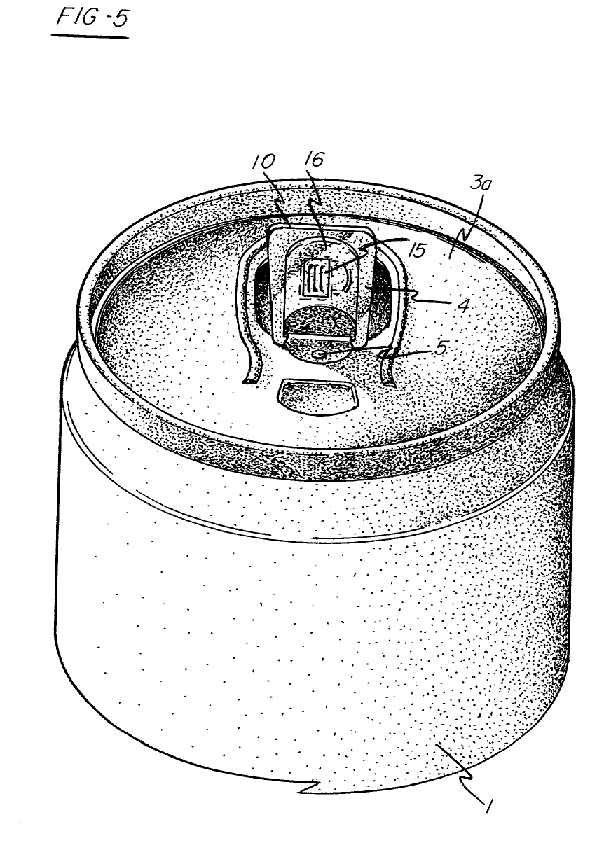

Turning now to FIGS. 4 and 5, an easy opening can container 1 having a tab 4 is shown. The tab 4 as illustrated has been moved into substantial perpendicular disposition with the upper end wall 3a of the can container 1. This movement is effected by manually pulling the outer edge 10 of the tab 4 upwardly away from the upper end wall 3a of the container 1. The resultant positioning of the tab 4 effects a unique visual communication. This communication may effect a signal to a bar tender or server that the container 1 is empty or near empty and that another, or second, full container having the same contents is desired.

In a related embodiment, an upper surface 12 of the tab 4 is further modified or shaped to support at least one visual indicia 14 which further emphasizes the signal to a bar tender or server that the container 1 is empty or near empty and that another, or second, full container having the same contents is desired. The visual indicia 14 may consist of a mark, shape, incising, imprint, color, depression, cut, mold, impression, etc. visually forming a symbol, number, letter, word, name, graphic, or other visual cue. Examples of the visual indicia 14 include a full beer mug (as shown in FIG. 4), full glass, the words “more drink”, a racing-style finish flag, a “thumbs up” graphic, a “hand up” shape or image, a traffic signal showing a green light, a colored flag, a container image shaped similarly to the actual full size container, a unique color, etc. These examples of visual indicia are provided for illustrative purposes only and should not be construed as limiting the scope of the invention.

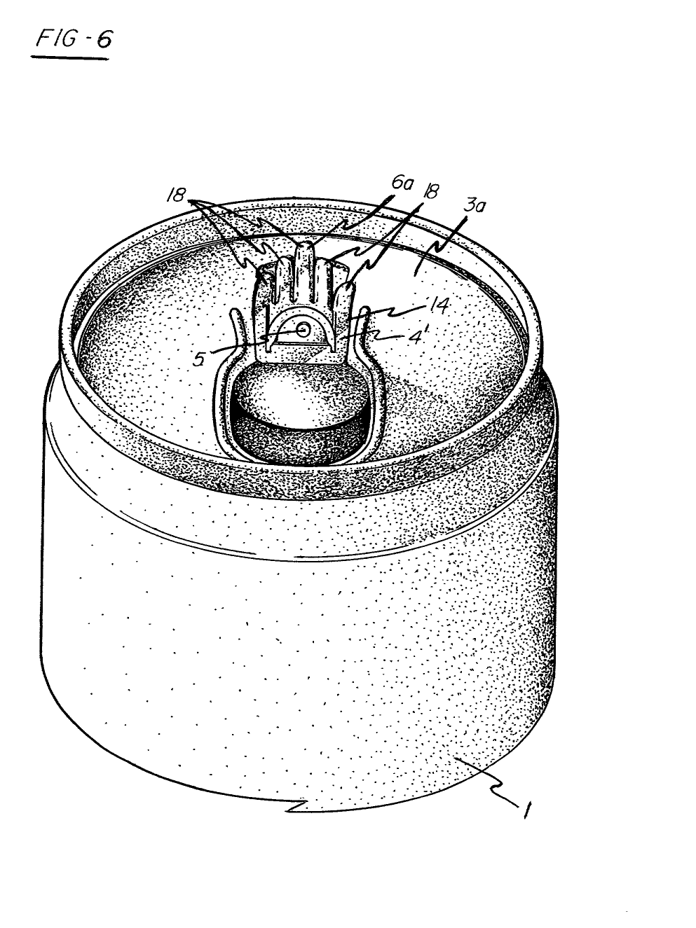

The aforementioned “hand up” image is illustrated in greater detail in FIG. 6 wherein the tab 4′ is shaped in the form of a person's hand including a plurality of parallel disposed fingers 18. At least one of the fingers 18 may serve as the indicator 6a identified above when the tab 4′ is positioned in substantially parallel relation to the upper end wall 3a of the container 1. When the tab 4′ is moved upwardly away from the upper end wall 3a into substantially perpendicular relation thereto, the fingers 18 serve to provide a unique visual communication to a server or other individual. More particularly, the fingers 18 in such an upright position signal that the container 1 requires replacement.

Referring further to FIG. 5, a further alternative embodiment of the invention is shown wherein the visual indicia 15 resulting from the modification or shaping of the tab 4 is supported on the lower surface 16 of the tab 4. As such, the signal effected by the indicia 15 of tab 4 is only viewable when the tab 4 is placed into substantial perpendicular disposition with the upper end wall 3a of the can container 1.

While the forms of apparatus described herein, and methods related thereto, constitute preferred embodiments of the invention, it should be appreciated that this in no way limits the scope of the invention as defined in the appended claims.

What is claimed is:

1. An apparatus for conveying a unique visual communication, said apparatus comprising:
a first container having an upper end wall;
a tab pivotally supported by said upper end wall; and
at least one visual indicia supported by said tab, wherein movement of said tab into substantial perpendicular disposition with said upper end wall causes said at least one visual indicia to effect a unique visual communication.

2. The apparatus as described in claim 1, wherein said at least one visual indicia indicates a request for a second container.

3. The apparatus as described in claim 2, wherein said tab includes a lower surface, and said at least one visual indicia is supported by said lower surface.

4. The apparatus as described in claim 1, wherein said tab includes a lower surface, and said at least one visual indicia is supported by said lower surface.

5. The apparatus as described in claim 1 wherein said at least one visual indicia comprises said tab formed in the shape of a hand.

6. The apparatus as described in claim 1, wherein:
said tab is rotatably supported at a connection point proximate the center of said upper end wall, said tab including an indicator selectively movable along a path of rotation; and
a plurality of visual indicia are circumferentially spaced and supported by said upper end wall, said plurality of visual indicia disposed radially outwardly from said connection point of said tab and substantially aligned with said path of rotation of said indicator, wherein said indicator is selectively movable into alignment with any one of said plurality of visual indicia for conveying a second unique visual communication.

7. The apparatus as described in claim 6 wherein said tab includes a plurality of fingers defining the shape of a hand, at least one of said fingers defining said indicator.

8. The apparatus as described claim 2, wherein:
said tab is rotatably attached to a connection point proximate the center of said upper end wall, said tab including an indicator selectively movable along a path of rotation; and
a plurality of visual indicia are circumferentially spaced and supported by said upper end wall, said plurality of visual indicia disposed radially outwardly from said connection point of said tab and substantially aligned with said path of rotation of said indicator, wherein said indicator is selectively movable into alignment with any one of said plurality of visual indicia for conveying a second unique visual communication.

9. A method for conveying a first unique visual communication, said method comprising the steps of:
providing a tab pivotally supported by an upper end wall of a first container; and
pivoting said tab upwardly into a position substantially perpendicular to said upper end wall of said first container for conveying said first unique visual communication.

10. The method of claim 9, wherein said first unique visual communication consists of the request for a second container.

11. The method of claim 9, wherein said tab supports visual indicia which further facilitates said conveying of said first unique visual communication.

12. The method of claim 10, wherein said tab supports visual indicia which further facilitates said conveying of said first unique visual communication.

13. The method of claim 11, wherein said visual indicia is fully visible only when said tab is extended upwardly from said upper end wall of said first container.

14. The method of claim 12, wherein said visual indicia is fully visible only when said tab is extended upwardly from said upper end wall of said first container.

15. The method of claim 9, further comprising the steps of:
providing an indicator supported by said tab, said indicator selectively movable along a path of rotation;
rotatably supporting said tab at said connection point;
providing a plurality of visual indicia disposed in a circumferentially spaced series along said container upper end wall, said plurality of visual indicia positioned radially outwardly from said connection point of said tab and in substantial circumferential alignment along said path of rotation of said indicator; and
rotating said tab for positioning said indicator in selective alignment with any one of said plurality of visual indicia for conveying a second unique visual communication.

16. The method of claim 15, wherein said first unique visual communication consists of the request for a second container.
